(19) United States
(12) Patent Application Publication
(10) Pub. No.: US 2007/0072661 A1
(43) Pub. Date: Mar. 29, 2007

(54) Windows message protection

(76) Inventor: Alexander Lototski, Fremont, CA (US)

Correspondence Address: GUNNISON, MCKAY & HODGSON, L.L.P., 1900 GARDEN ROAD, SUITE 220, MONTEREY, CA, 93940, US

(21) Appl. No.: 11/237,196

(22) Filed: Sep. 27, 2005

(51) Int. Cl. A63F 13/00

(52) U.S. Cl. 463/1

(57) ABSTRACT

Systems and methods for computer security are provided. In one implementation, a method is provided that includes monitoring for an incoming windows message directed to a graphical user interface element. The method also includes analyzing a received windows message to determine the validity of the received windows message, and preventing the windows message from being processed by the graphical user interface element if the windows message if the windows message is not valid.

### BACKGROUND

The present invention relates to computer security.

In conventional computer systems, users can interact with software applications through graphical user interface (“GUI”) controls. When a user interacts with an application, the operating system can generate one or more notification messages. Windows messages can be part of the notification messages sent to GUI elements which represent themselves as windows. Different operating systems can have different notification messages, e.g., Microsoft Windows, produce windows messages for windows notifications. The windows messages are transmitted to a corresponding GUI element. GUI elements can include toolbars, buttons, and tables. In conventional computer systems, the windows messages can be generated by the user, the operating system, or by another program. Example actions that can cause a windows message to be generated include received user input such as moving a cursor with a mouse, making a keystroke, resizing a dialog box, or other application activity. Typically, the GUI elements used by the software application each include processing code for processing incoming windows messages. A conventional windows message includes data identifying the type of windows message. Different operating systems identify windows messages in different ways. For example, a windows message in the Microsoft Windows operating system includes an identification having a numerical value from 1 to 65535 and two parameters. The two parameters typically point to data structures associated with the particular type of windows message.

A malicious program can initiate a windows message attack. A windows message attack is premised on sending a windows message that will be incorrectly processed by the target GUI element in the attacked application. The incorrect processing can result in unexpected behavior including crashing the application. A typical malicious program attacks not only the main application window but also child windows or other GUI elements that are associated with the application.

Typically, the malicious program identifies and enumerates the GUI elements associated with the attacked application. The malicious program then transmits a series of invalid windows messages to each of the GUI elements. If the attacking windows message causes the target application to crash, the malicious program ends. If the attacking windows message does not cause the target application to crash, the malicious program can cycle to the next windows message value and attack the GUI element again. If there are no more windows message values left to try, the malicious program can move on to attack the next GUI element in the application repeating the process of sending invalid windows messages for each GUI element until the application crashes.

### SUMMARY

Systems and methods for computer security are provided. In general, in one aspect, a method is provided. The method includes monitoring for an incoming windows message directed to a graphical user interface element. The method further includes analyzing a received windows message to determine the validity of the received windows message, and preventing the windows message from being processed by the graphical user interface element if the windows message if the windows message is not valid.

Implementations can include one or more of the following features. The method can further include intercepting the incoming windows message directed to a graphical user interface element. The intercepting can include hooking the windows message to redirect the windows message to a filter. The method can further include verifying the windows message according to the analysis. The method can further include passing the windows message to the graphical user interface element for processing if the windows message is verified.

The analyzing can include identifying a particular type of the windows message. The analyzing can also include identifying one or more parameters associated with the windows message and/or identifying a signature in the windows message. The verifying can include determining whether parameters of the windows message are valid for a particular type of windows message. The method can include otherwise processing the windows message if the windows message is not verified. The otherwise processing can include logging, or alerting.

In general, in one aspect, an apparatus is provided. The apparatus includes a GUI element. The GUI element includes a filter operable to block unverified windows messages from processing and a GUI processor operable to process windows messages.

Implementations can include one or more of the following features. The filter can further include a monitoring engine for identifying received communications as windows messages directed to the GUI element. The filter can further include an analysis engine for examining a received windows message and a verification engine operable to determine whether a received windows message is valid. The filter can further include an alert engine for generating one or more responses to an unverified windows message including alerting a user, alerting a security system, or logging the windows message.

In general, in another aspect, a filter is provided. The filter includes a monitoring engine for identifying received communications as windows messages directed to one or more GUI elements and an analysis engine for analyzing a received windows message to determine the validity of the received windows message. The filter can also include a verification engine operable to verify the received windows message based on the analysis and an alert engine for generating one or more responses to an unverified windows message including alerting a user, alerting a security system, or logging the windows message.

In general, in one aspect, a computer program product, tangibly stored on a computer-readable medium, for protecting against windows message attacks is provided. The computer program produce includes instructions operable to cause a programmable processor to monitor for an incoming windows message directed to a graphical user interface element. The computer program product also includes instructions to analyze a received windows message to determine the validity of the received windows message, and prevent the windows message from being processed by the graphical user interface element if the windows message if the windows message is not valid.

The invention can be implemented to realize one or more of the following advantages. An application can be protected from windows message attacks by protecting the individual target GUI elements of the application. A particular GUI element can be protected by an internal filter or though an external filter protecting a number of GUI elements. Attacking windows messages can be blocked by the filter in order to prevent improper processing by the target GUI element, application crashing, or compromising the safe behavior of the application.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 shows a functional block diagram of a computing system.

FIG. 2 shows a screenshot of an application illustrating different GUI elements.

FIG. 3 shows a block diagram implementation of windows message protection system when a windows message filter is located inside a GUI element.

FIG. 4 shows a block diagram of another implementation of a windows message protection system when the windows message filter is located outside the GUI elements and redirects windows message distribution.

FIG. 5 shows a block diagram of a filter.

FIG. 6 shows a method for filtering windows messages.

FIG. 7 shows another method for filtering windows messages.

FIG. 8 shows a computer system.

Like reference numbers and designations in the various drawings indicate like elements.

### DETAILED DESCRIPTION

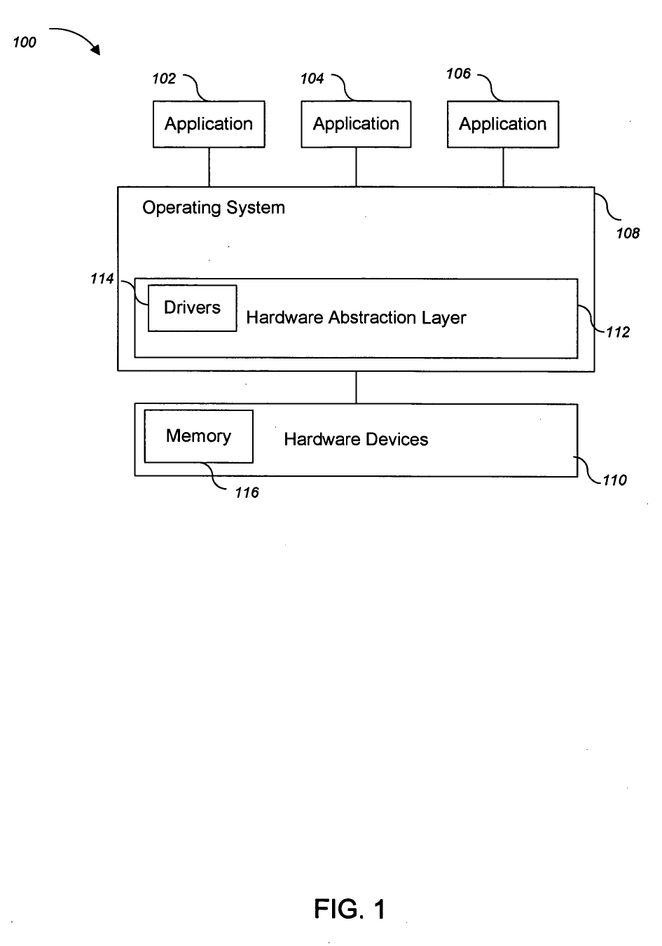

FIG. 1 illustrates a functional block diagram of a computing system 100. The computing system 100 includes applications 102, 104, and 106, which can be directly accessed, modified, or interacted with by a user, for example, using a GUI. The computing system 100 also includes an operating system 108 and hardware devices 110.

The applications 102-106 can include applications accessible by a user for performing different functions with the computing system 100. For example, the applications 102-106 can include word processing, database management, email applications, and any other user managed applications. The applications 102-106 can provide different functionality in response to user input. For example, in a word processing application a user can open a file, create a new file, and save a file in response to user input as well as display input text, tables, and drawing objects. The applications 102-106 can include a GUI that allows the user to interact with the application, for example, through menus, buttons, and toolbars. The user can employ one or more input devices (e.g., part of hardware devices 110) to manipulate the application through the GUI, including a mouse or keyboard.

The operating system 108 manages the computer system 100 including the hardware devices 110. Additionally, the operating system 108 provides applications 102-106 with an interface to the hardware devices 110. In one implementation, the operating system 108 provides a graphical user interface from which the user can interact with aspects of the computer system 100 including selecting and opening applications 102-106.

The operating system includes a hardware abstraction layer 112. The hardware abstraction layer 112 allows different software to be device-independent by abstracting information from systems such as caches, I/O buses, and interrupts and using hardware data to provide applications 102-106 a way to interact with the specific requirements of the hardware devices 110 on which the applications 102-106 or a portion thereof are running. In one implementation, the hardware abstraction layer 112 includes drivers 114 that can be used to control the hardware devices 110 by providing access to registers of the hardware devices 110.

The hardware devices 110 can include physical devices for operating the computer system 100. The hardware devices 110 can include storage devices such as memory 116, processing devices such as a CPU, and input/output devices such as a monitor, mouse, or keyboard.

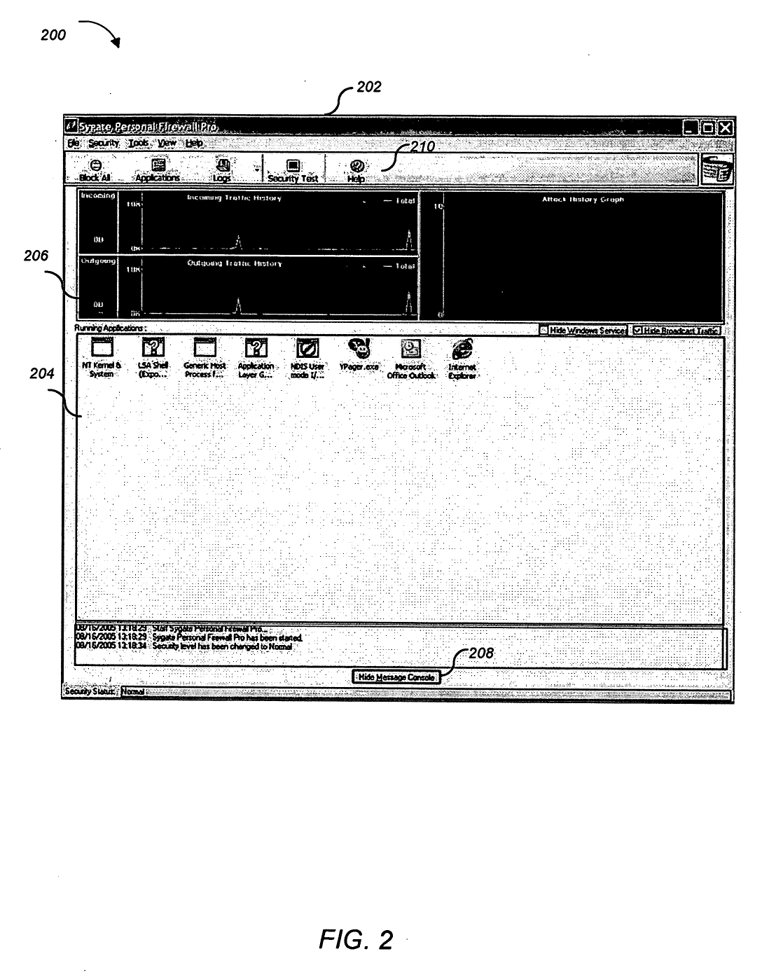

FIG. 2 shows an example of a GUI 200 for application 102. The graphical user interface includes a main application window 202 and several GUI elements including child window GUI elements 204 and 206, button GUI element 208, and toolbar GUI element 210. The main application window 202 can include additional GUI elements. In one implementation, substantially all of the programming elements used by the application 102 are GUI elements.

The GUI elements 204-210 can each provide different functionality allowing a user to interact with the application 102. In one implementation, user interaction with the application 102 through the GUI 200 can cause the operating system 108 to generate a windows message directed to one or more of the GUI elements 204-208. Each GUI element 204-208 can include windows message processing code for processing received windows messages. For example, a user selection of button GUI element 208 can cause the operating system to generate a windows message to the button GUI element 208 that causes the GUI element to reflect a selected state. Additionally, other windows messages can be generated as a result of the user input selecting the button GUI element 208 which affect other GUI elements of the application 102.

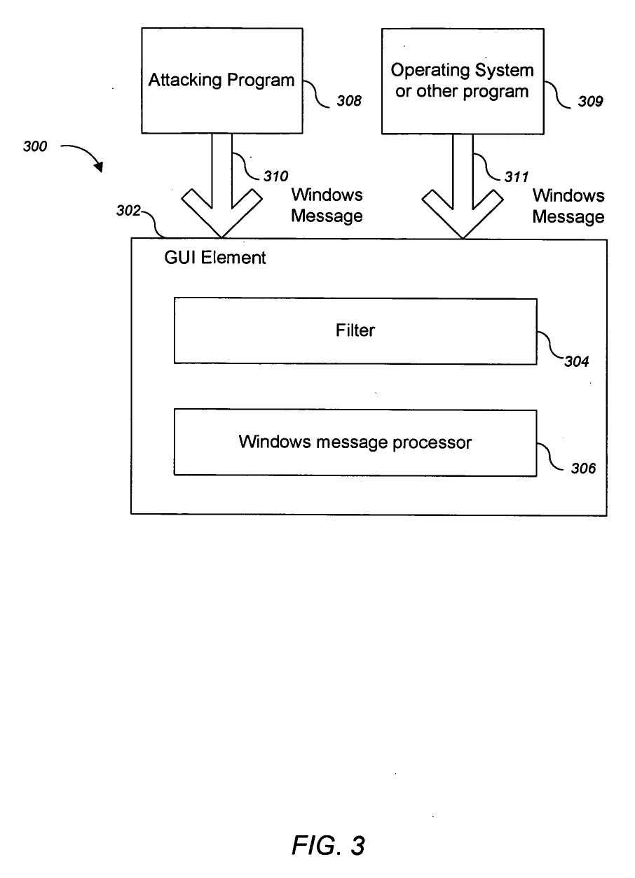

In one implementation, a malicious program can be designed to attack the main application window 202 as well as one or more of the GUI elements 204-208. FIG. 3 shows one implementation of a windows message protection system 300 for a GUI element to protect against attacks from a malicious windows message program. Windows message protection system 300 includes a GUI element 302. The GUI element 302 includes a filter 304 and a windows message processor 306. The filter 304 can intercept incoming windows messages 310 from an attacking program 308 as well as valid windows messages 311 sent by operating system 309. In one implementation, the windows messages can be generated from other sources.

The attacking program 308 can transmit one or more windows messages 310 to the GUI element 302 in order to cause the GUI element 302 to incorrectly process the windows message 310 causing incorrect behavior including behavior resulting in the application 102 crashing.

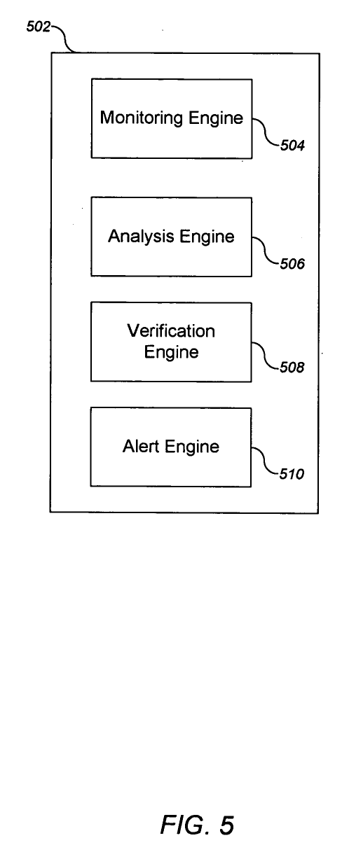

In one implementation, the filter 304 can block attacking windows messages 310 while allowing valid windows messages 311 to pass through the filter 304 to the windows message processor 306. One implementation of the filter 304 is disclosed in further detail below with respect to FIG. 5. The windows message processor 306 can include processing code for processing windows messages for the GUI element 302. The GUI element 302 can then provide an appropriate response to the user based on the processed windows message.

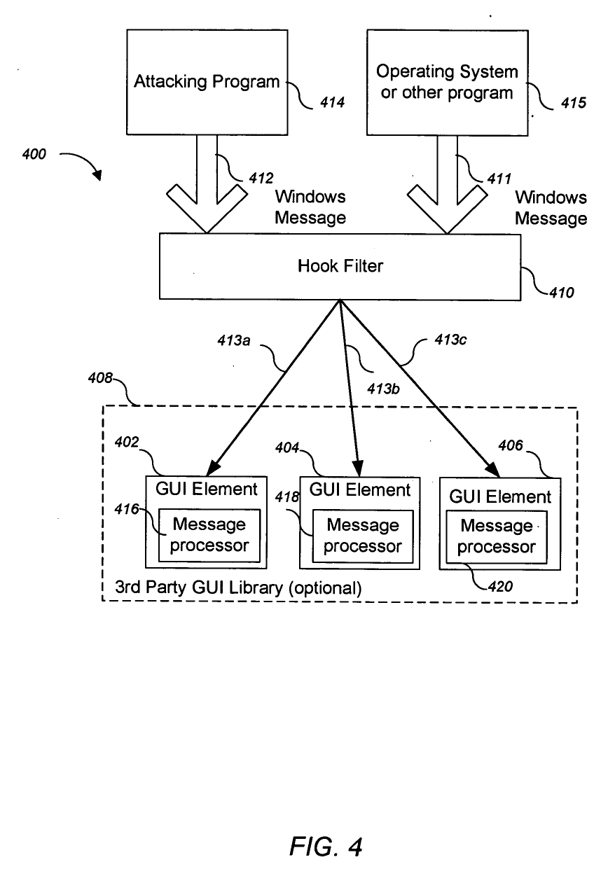

FIG. 4 shows another implementation of a windows message protection system 400 for GUI elements. The windows message protection system 400 includes GUI elements 402, 404, and 406. The GUI element 402, 404, 406 can optionally be included within a single 3rd party GUI Library 408. The windows message protection system 400 also includes a hook filter 410. The hook filter 410 is positioned to intercept windows messages 412, 411 directed to the GUI elements 402, 404, and 406, for example, from attacking program 414 or from operating system 415. In an alternative implementation, windows messages can be received from other sources.

The GUI elements 402, 404, and 406 each include a windows message processor 416, 418, and 420 respectively. The windows message processors 416, 418, and 420 can include processing code for processing windows messages for the GUI elements 402, 404, and 406. Each GUI element 402, 404, and 406 can provide an appropriate response to the user based on the processed windows message. In one implementation, the GUI elements 402, 404, and 406 include proprietary code from a 3rd party such that a filter (e.g., filter 304 of FIG. 3) cannot be inserted directly into the GUI elements 402, 404, and 406.

The attacking program 414 can transmit one or more windows messages 412 directed to one or more of the GUI elements 402, 404, and 406 in order to cause the GUI elements 402, 404, and 406 to incorrectly process the windows message 412 causing incorrect behavior, which for example, causes the application to crash or provide some other error response.

The hook filter 410 can intercept windows messages, including windows messages 412 and 411 transmitted by attacking program 414 and operating system 415, respectively, before they reach GUI elements 402, 404, or 406. The hook filter 410 can process the intercepted windows messages 411, 412 in order to determine whether the windows message can proceed to the designated GUI element 402, 404, or 406. Windows messages that are allowed to proceed (e.g., windows messages 411) are directed to GUI elements 402, 404, or 406 as windows messages 413a, 413b, or 413c respectively.

In one implementation, a windows message hook can be injected to monitor for, and redirect, windows messages to one or more GUI elements. The windows message hook can be injected into a particular application or to several applications. If the windows message hook identifies a windows message for which the hook is monitoring, the windows message hook can cause the windows message to be redirected for processing by the hook filter 410. The hook filter 410 can then perform one or more functions on the windows message, including verifying the windows message, prior to directing the windows message to the destination GUI element.

More specifically, in one implementation, the windows message hook can be injected into machine instructions associated with one or more particular windows messages. The windows message hook can then modify the machine instructions associated with that windows message. When a hooked windows message is being processed by the machine instructions, the hook modified instructions are executed in place of the original instructions. In one implementation, the windows message hook inserts a jump command that points to the hook filter 410. The jump command is a pointer that redirects the windows message to the hook filter 410.

The hook filter 410 can include instructions corresponding to one or more functions to be performed. For example, in one implementation, the hook filter 410 is part of a security system. The security system can monitor one or more applications for windows messages from malicious software such as spyware, viruses, Trojans, or other malicious code, which can harm the computing system 100. The security system can examine intercepted windows messages to prevent the malicious software from interfering with one or more applications.

FIG. 5 shows one implementation of a filter 502 for providing protection from windows message attacks. The filter 502 includes a monitoring engine 504, an analysis engine 506, a verification engine 508, and an alert engine 510.

The monitoring engine 504 monitors for incoming windows messages. In one implementation where the filter 502 is included within a GUI element (e.g., GUI element 302), the monitoring engine 504 monitors for any windows message incoming into the GUI element. In an alternative implementation, where the filter 502 is a hook filter (e.g., hook filter 410), the monitoring engine 504 monitors for windows messages directed to one or more GUI elements of an application.

In one implementation, the monitoring engine 504 can monitor for incoming windows messages that have been redirected by an injected windows message hook. The windows message hook can intercept windows messages at a point external to one or more protected GUI elements. The windows message hook can be configured to intercept particular windows messages and redirect the windows messages to the filter 502.

The analysis engine 506 can examine windows messages. The analysis engine 506 can examine received or intercepted windows messages for parameters indicating that the windows message is valid. The analysis engine 506 can examine the windows message to determine the type of windows message. In one implementation, the analysis engine can compare parameter values for particular windows messages with the received windows message. In another implementation, the analysis engine can identify a signature of the windows message. For example, the analysis engine 506 can search the windows message for a particular signature identifying the source of the windows message.

The verification engine 508 can use the results of the analysis engine 508 to determine whether or not the windows message is valid and can be processed by the target GUI element. For example, if the analysis engine 506 identifies a signature in the windows message indicating that the windows message originated from a valid source, the verification engine 508 can verify the windows message and allow the windows message to proceed. In another example, if the verification engine 508 is unable to verify the windows message based on the results of the analysis engine 506, the windows message can be blocked. In one implementation, the analysis engine 506 and the verification engine 510 can be the same engine.

The alert engine 510 can provide a number of different alerts according to the results of the analysis and verification performed by the analysis engine 506 and verification engine 508. In one implementation, the alert engine 510 can otherwise process an invalid message. The otherwise processing can include logging the invalid windows message, alerting a user of a computer system to the invalid windows message, alerting a security system, or other action. For example, the security system can be alerted such that the security system can perform system analysis, scanning, or other cleaning routine in order to identify the source of the malicious program responsible for the windows message attack.

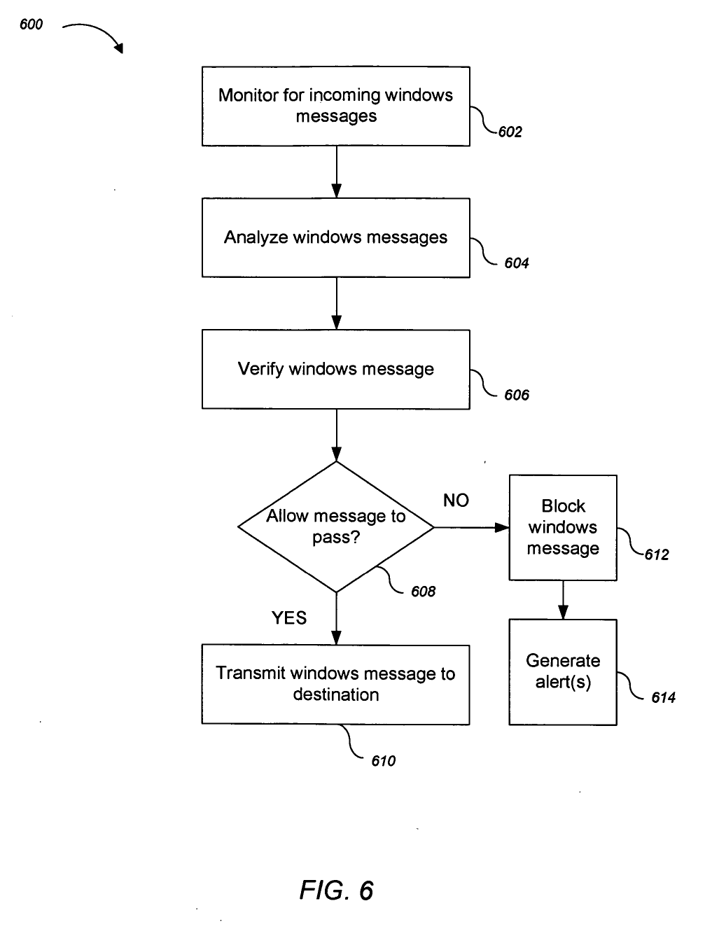

FIG. 6 shows a method 600 for protecting a GUI element from windows message attacks using a filter included in a GUI element. A filter (e.g., filter 304) monitors for incoming windows messages to the GUI element (e.g., GUI element 302) (step 602). The filter can monitor for incoming windows messages using, for example, a monitoring engine (e.g., monitoring engine 504). The monitoring engine can identify the type of incoming communication to determine whether or not a windows message is entering the GUI element. For example, the monitoring engine can monitor for particular windows messages and ignore other communications.

When the filter detects an incoming windows message, the filter can analyze the received windows message (e.g., using analysis engine 506) (step 604). Analyzing the windows message can include identifying the type of the windows message. In one implementation, the parameter values of the windows message can be analyzed. The parameter values can specify particular program structures for a particular windows message. A windows message having a particular identification value can therefore be associated with particular parameters valid for the particular windows message. The analysis engine can compare the valid parameter values for a particular windows message with the received parameter values.

In another implementation, the analysis engine can identify one or more signatures within the windows message identifying the source of the windows message. For example, particular windows messages (e.g., to quit an operation of the GUI element), can have a particular sum associated with the parameter values of the windows message. The analysis can compare the sum of the parameter values with a value in a lookup table for that particular type of windows message. In one implementation, a signature is only checked for particular critical windows messages. Other types of identifiers (e.g., digital signatures or stamps), can also be used to identify the source of windows messages.

The filter can then verify the authenticity of the windows message (e.g., using verification engine 508) according to the results of the analysis (step 606). In one implementation, the verification includes matching the parameter values of the windows message with valid parameter values for the particular type of windows message. In another implementation, verification includes validating the identified signatures from the windows message as authentic.

In one implementation, the verification results are used to determine whether or not the windows message is allowed to pass from the filter (step 608). The windows message can be allowed to pass through the filter to be processed by the GUI element (e.g., by windows message processor 306) when the windows message has been verified. The verified windows message is then directed to the destination in the GUI element for processing (step 610).

If the windows message is not allowed to pass, for example, because the windows message failed the verification step 606, the windows message is blocked (step 612). The blocked windows message is terminated so that it is not processed by the windows message processor where the windows message can harm the operation of the GUI element or the entire application.

The windows message can be otherwise processed if the windows message is not allowed to pass. For example, the filter can generate one or more alerts (e.g., using alert engine 510) in response to the blocked windows message (step 614). Generated alerts can include recording the windows message in a log, alerting a user of the blocked windows message, and alerting a security system of the attempted security breach. The security system can then execute one or more routines to identify and remove the malicious application that was the source of the windows message.

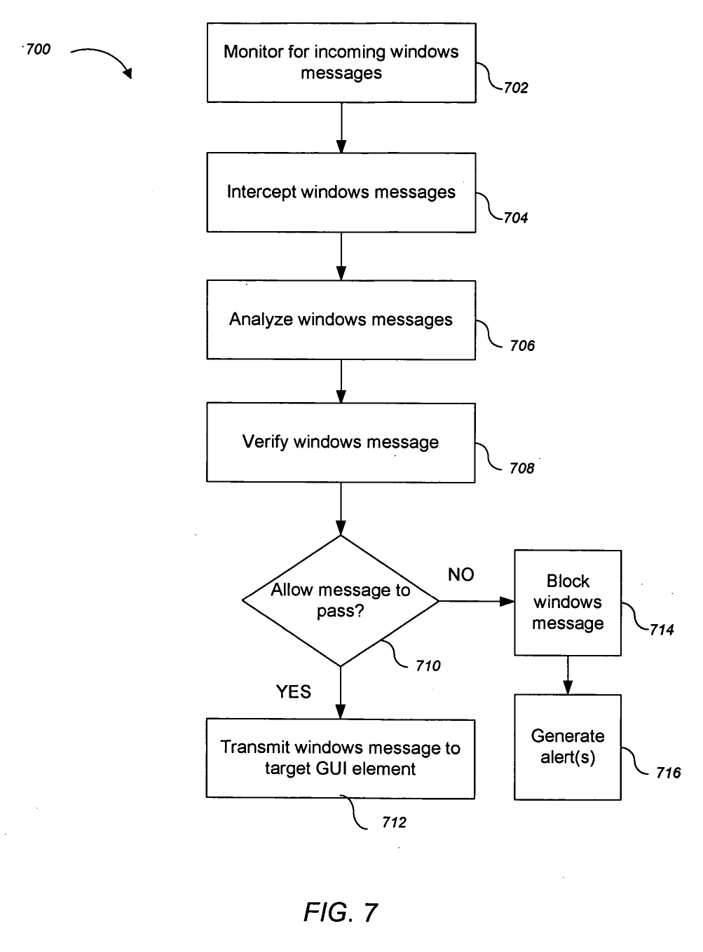

FIG. 7 shows a method 700 for protecting GUI elements from windows message attacks using a hook filter. A hook filter (e.g., hook filter 410) monitors for incoming windows messages to one or more GUI elements (e.g., GUI element 402) (step 702). The hook filter can monitor for incoming windows messages using, for example, a monitoring engine (e.g., monitoring engine 504). The hook filter can receive windows messages redirected by a windows message hook inserted to monitor communications to one or more designated GUI elements in order to identify windows messages directed to the designated GUI elements. The monitoring engine can identify the type of incoming communication to determine whether or not a windows message is directed towards a GUI element protected by the hook filter.

If the monitoring engine detects a windows message directed to one of the designated GUI elements, the windows message can be intercepted (e.g., by interception engine 505) (step 704). The interception engine redirects the windows message from the target GUI element such that the hook filter can process the windows message.

When a windows message is intercepted, the hook filter can analyze the windows message (e.g., using analysis engine 506) (step 706). Analyzing the windows message can include identifying the type or source of the windows message. In one implementation, the parameter values of the windows message can be analyzed. The parameter values can specify particular program structures for a particular windows message. A windows message having a particular identification value can therefore be associated with particular parameters valid for the particular windows message. The analysis engine can compare the valid parameter values for a particular windows message with the received parameter values.

In another implementation, the analysis engine can identify one or more signatures within the windows message identifying the type of the windows message. For example, particular windows messages (e.g., to quit an operation of the GUI element), can have a particular sum associated with the parameter values of the windows message as discussed above. The analysis can compare the sum of the parameter values with a value in a lookup table for that particular type of windows message. In one implementation, a signature is only checked for particular critical windows messages. Other types of identifiers (e.g., digital signatures or stamps), can also be used to identify the source of windows messages.

The hook filter can then verify the authenticity of the windows message (e.g., using verification engine 508) according to the results of the analysis (step 708). Verification can include verifying that the type of the windows message is of a permitted type for windows messages directed to the target GUI element. Alternatively, verification can include verifying the source of the windows message as permitted. In one implementation, the verification includes matching the parameter values of the windows message with valid parameter values for the particular type of windows message. In another implementation, verification includes validating the identified signatures from the windows message as authentic.

In one implementation, the verification results are used to determine whether or not the windows message is allowed to pass from the filter (step 710). The windows message can be allowed to pass such that the hook filter transmits the windows message to the designated GUI element for processing (e.g., by windows message processor 306) when the windows message has been verified (step 712).

If the windows message is not allowed to pass, for example, because the windows message failed the verification step 708, the hook filter blocks the windows message (step 714). The blocked windows message is terminated so that it is not transmitted to the target GUI element where the windows message can harm the operation of the application.

Additionally, the hook filter can generate one or more alerts (e.g., using alert engine 510) in response to the blocked windows message (step 716). Generated alerts can include recording the windows message in a log, alerting a user of the blocked windows message, and alerting a security system of the attempted security breach. The security system can then execute one or more routines to identify and remove the malicious application that was the source of the windows message.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

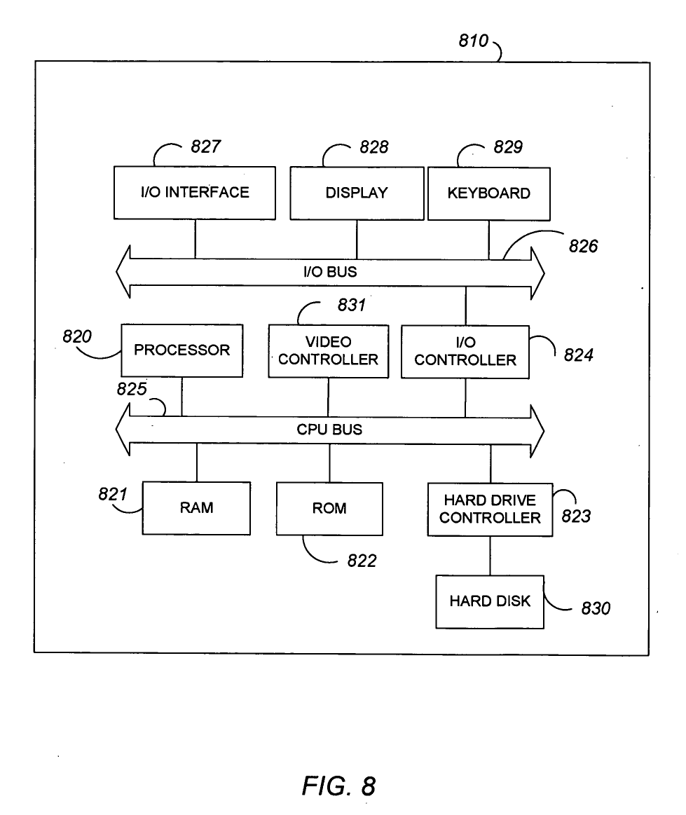

An example of one such type of computer is shown in FIG. 8 which shows a block diagram of a programmable processing system (system) 810 suitable for implementing or performing the apparatus or methods of the invention. The system 810 includes a processor 820, a random access memory (RAM) 821, a program memory 822 (for example, a writable read-only memory (ROM) such as a flash ROM), a hard drive controller 823, a video controller 831, and an input/output (I/O) controller 824 coupled by a processor (CPU) bus 825. The system 810 can be preprogrammed, in ROM, for example, or it can be programmed (and reprogrammed) by loading a program from another source (for example, from a floppy disk, a CD-ROM, or another computer).

The hard drive controller 823 is coupled to a hard disk 830 suitable for storing executable computer programs, including programs embodying the present invention.

The I/O controller 824 is coupled by means of an I/O bus 826 to an I/O interface 827. The I/O interface 827 receives and transmits data (e.g., stills, pictures, movies, and animations for importing into a composition) in analog or digital form over communication links such as a serial link, local area network, wireless link, and parallel link.

Also coupled to the I/O bus 826 are a display 828 and a keyboard 829. Alternatively, separate connections (separate buses) can be used for the I/O interface 827, display 828 and keyboard 829.

The invention has been described in terms of particular embodiments. Other embodiments are within the scope of the following claims. For example, the steps of the invention can be performed in a different order and still achieve desirable results.

What is claimed is:

1. A method, comprising:
monitoring for an incoming windows message directed to a graphical user interface element;
analyzing a received windows message to determine the validity of the received windows message; and
preventing the windows message from being processed by the graphical user interface element if the windows message if the windows message is not valid.

2. The method of claim 1, further comprising:
intercepting the incoming windows message directed to a graphical user interface element.

3. The method of claim 2, where intercepting the windows message includes hooking the windows message to redirect the windows message to a filter.

4. The method of claim 1, further comprising:
verifying the windows message according to the analysis.

5. The method of claim 1, further comprising:
passing the windows message to the graphical user interface element for processing if the windows message is verified.

6. The method of claim 1, where the analyzing include identifying a particular type of the windows message.

7. The method of claim 1, where the analyzing includes identifying one or more parameters associated with the windows message.

8. The method of claim 1, where the analyzing includes identifying a signature in the windows message.

9. The method of claim 1, where the verifying includes determining whether parameters of the windows message are valid for a particular type of windows message.

10. The method of claim 1, further comprising:
otherwise processing the windows message if the windows message is not verified.

11. The method of claim 10, where the otherwise processing includes logging, or alerting.

12. An apparatus, comprising:
a graphical user interface (“GUI”) element, including:
a filter operable to block unverified windows messages from processing; and
a GUI processor operable to process windows messages.

13. The apparatus of claim 12, where the filter further comprises:
a monitoring engine for identifying received communications as windows messages directed to the GUI element.

14. The apparatus of claim 12, where the filter further comprises:
an analysis engine for examining a received windows message.

15. The apparatus of claim 12, where the filter further comprises:
a verification engine operable to determine whether a received windows message is valid.

16. The apparatus of claim 15, where the filter further comprises:
an alert engine for generating one or more responses to an unverified windows message including alerting a user, alerting a security system, or logging the windows message.

17. A filter, comprising:
a monitoring engine for identifying received communications as windows messages directed to one or more GUI elements; and
an analysis engine for analyzing a received windows message to determine the validity of the received windows message.

18. The filter of claim 17, further comprising:
a verification engine operable to verify the received windows message based on the analysis.

19. The filter of claim 17, further comprising:
an alert engine for generating one or more response to an unverified windows message including alerting a user, alerting a security system, or logging the windows message.

20. A computer program product, tangibly stored on a computer-readable medium, for protecting against windows message attacks, comprising instructions operable to cause a programmable processor to:
monitor for an incoming windows message directed to a graphical user interface element;
analyze a received windows message to determine the validity of the received windows message; and
prevent the windows message from being processed by the graphical user interface element if the windows message if the windows message is not valid.

21. The computer program product of claim 20, further comprising instructions to:
intercept the incoming windows message directed to a graphical user interface element.

22. The computer program product of claim 21, where the instructions to intercept the windows message include instructions to hook the windows message to redirect the windows message to a filter.

23. The computer program product of claim 20, further comprising instructions to:
verify the windows message according to the analysis.

24. The computer program product of claim 20, further comprising instructions to:
pass the windows message to the graphical user interface element for processing if the windows message is verified.

25. The computer program product of claim 20, where the instructions to analyze include instructions to identify a particular type of the windows message.

26. The computer program product of claim 20, where the instructions to analyze include instructions to identify one or more parameters associated with the windows message.

27. The computer program product of claim 20, where the analyzing includes identifying a signature in the windows message.

28. The computer program product of claim 20, where the verifying includes determining whether parameters of the windows message are valid for a particular type of windows message.

29. The computer program product of claim 20, further comprising instructions to:
otherwise process the windows message if the windows message is not verified.

30. The computer program product of claim 29, where the instructions to otherwise process includes logging, or alerting.
